(19) United States
(12) Patent Application Publication
(10) Pub. No.: US 2004/0218911 A1
(43) Pub. Date: Nov. 4, 2004

(54) Portable system for inputting, editing, and outputting digital multimedia data

(76) Inventor: Ariel S. Grimes, New York, NY (US)

Correspondence Address: ARIEL S. GRIMES, 549 FDR DRIVE, APT. #6A, NEW YORK, NY, 10002, US

(21) Appl. No.: 09/776,114

(22) Filed: Feb. 5, 2001

(51) Int. Cl. H04N 5/76

(52) U.S. Cl. 386/117

(57) ABSTRACT

A portable system for inputting, editing, and outputting digital multimedia data, that includes a PCMCIA memory card, a camcorder, a digital camera, a TV, and a computer. The camcorder, the digital camera, or the VCR directly receives therein the PCMCIA memory card, and records thereon, digital multimedia data of what is being recorded by the camcorder, the digital camera, or the VCR. The TV is operatively connected to the VCR. The VCR alternatively directly receives therein the PCMCIA memory card and allows the TV to play the digital multimedia data stored on the PCMCIA memory card directly received in the VCR. The computer directly receives therein the PCMCIA memory card, and saves thereon, digital multimedia data of what is being saved by the computer. The computer, alternatively, directly receives therein the PCMCIA memory card and plays the digital multimedia data recorded on the PCMCIA memory card by one of the camcorder, the digital camera, the VCR, and the computer, respectively. The computer, alternatively, directly receives therein the PCMCIA memory card and allows the digital multimedia data recorded on the PCMCIA memory card by one of the camcorder, the digital camera, the VCR, and the computer, respectively, to be edited.

### BACKGROUND OF THE INVENTION

1. Field of the Invention

The present invention relates to a system for inputting, editing, and outputting multimedia. More particularly, the present invention relates to a portable system for inputting, editing, and outputting digital multimedia data.

2. Description of the Prior Art

Live action or full motion video has been used with personal computers, particularly for so-called multimedia presentations where different types of media are combined to present information to a user. In addition, personal computers have been increasingly used in video applications to manipulate video signals (e.g., editing, computer animation, or the like).

Motion video is interpreted to mean any video segment or presentation including live action, real time, or full motion video. Examples of motion video include, but are not limited to, NTSC, PAL, SECAM, or MUSE type television signals, digital or analog HDTV signals, or the like, including live television signals or broadcasts, cable television signals or the like, or motion picture video, which may be suitably digitized and converted into a format suitable for presentation on a computer display. The term motion video may also include, but is not limited to, any computer generated display or display segment, including computer animation or the like.

For multimedia presentations, it is particularly useful to be able to provide a motion video interface to a portable or so-called notebook or laptop computer or the like (collectively refereed to hereinafter as “portable computer”) to display motion video on a computer screen or attached monitor or television. A separate video interface may be provided in a portable computer, tied to the system bus or incorporated into the video adapter in order to import motion video into the portable computer. Such an interface, however, would increase the cost of a personal or portable computer significantly. Since only a portion of computer users are envisioned as requiring such a video interface, it is desirable to be able to offer a video interface as an add-on option for a personal or portable computer.

In order to support optional features for portable or personal computers, an industry standard known as the PCMCIA standard has been developed to allow computer manufactures to offer optional features on a removable card, referred to as a PCMCIA card. Optional features such as modems, I/O ports, network interfaces, memory, and even hard drives have been incorporated into PCMCIA cards which may be used to upgrade a portable or personal computer to add such features.

Unfortunately, the PCMCIA standard has some inherent limitations, which make it difficult to adapt to video data transmission. For motion video, digitized under the CCIR 601 standard, for example, an average bandwidth of 27 megabytes per second may be required in order to transmit the video data from one device to another.

Modern high performance computers (e.g., Intel™, Pentium™, 486-33 MHz, or the like) using advanced bus structures such as the PCI or VESA bus architecture may have a memory bandwidth in the range of 25 to 35 megabytes per second. Thus, motion video data can be successfully transmitted within the bus structure of a high performance personal or portable computer. PCMCIA, however, has a bandwidth limitation of five megabytes per second. Thus, the PCMCIA interface acts as a bottleneck or barrier for transmitting continuous motion video to a portable or personal computer.

Various video compression techniques are known in the art and have been implemented to reduce bandwidth or increase channel space, for example, for satellite, cable TV, so-called “Video On Demandt” or other video services (e.g., Picturephone T or the like). One technique developed for black and white video transmission iLs described in “Block Truncation Coding: A New Approach to Image Compression,” O. R. Mitchell et al., Conference Records, IEEE International Conference on Communication I, June 1978, 12B.1.1-12B.1.4, which utilized a relatively simple technique. This technique relies upon the fact that the human eye generally does not ascertain all of the minute distinctions which may be present in a video signal. In order to provide a useful video image, one need only reproduce a video image which is visually indistinguishable from the transmitted image, regardless as to whether any of the quality of the data is lost.

Although, this technique reduces the analog pixel values to discrete levels, the system still requires at least one bit per pixel to transmit the luminance values (relative intensities) for each pixel in the matrix. In addition, the two moment values (mean and standard deviation) must also be transmitted for each matrix of pixels. This technique also does not provide for the transmission of color images. Finally, since the pixels are arranged in a matrix, the data must be serialized at the receiver in order to provide image data in a scan line format.

U.S. Pat. No. 5,642,139 to Eglit et al., overcomes these problems, by providing a PCMCIA card which can transmit full motion or live action video through PCMCIA host to a computer data bus, and which is included herein by reference thereto.

Numerous innovations for multimedia input and output devices have been provided in the prior art that will be described. Even though these innovations may be suitable for the specific individual purposes to which they address, however, they differ from the present invention.

FOR EXAMPLE, U.S. Pat. No. 4,706,117 to Schoolman teaches a portable television playback system that includes a video source unit, video processing circuitry, audio processing circuitry, and a stereo viewing and sound unit. The video source unit is a television receiver, a small videocassette tape cartridge player, or a stereo optical video disc player. The viewing and sound unit has stereoscopic and stereophonic capabilities and is generally a head worn unit having right and left image display devices and right and left earphones. The video and audio processing circuits receive the signals from the video source unit and parallel the video and audio signals to drive the stereo output devices if the source is a television receiver or a videocassette tape player or perform demultiplexing functions to separate the right and left video and audio signals from the right and left multiplexed video/audio signals. The video source unit and the video and audio processing circuits are packaged in a single portable case which may be connected to the head worn viewing and sound unit by an appropriate cable for use.

ANOTHER EXAMPLE, U.S. Pat. No. 5,214,514 to Haberkern teaches a video/sound apparatus in the form of a suitcase-like foldable housing, including a housing cover portion for accommodating a projection screen as well as a housing bottom portion for accommodating various control elements, the video/sound apparatus including further a video recording and playback device as well as auxiliary receptacles for connection with auxiliary equipment, with the two housing portions being joined to one another by a hinge member which contains the stereo speakers, and with the video/sound apparatus also being equipped with a TV receiving/reproduction section and a CD record player. While the video/sound apparatus according to the invention is very versatile with respect to its various functions which go beyond that of an apparatus for use strictly as a video/sound recorder, it is very compact and it combines the functions of a television, video recorder and CD record player.

STILL ANOTHER EXAMPLE, U.S. Pat. No. 5,511,000 to Kaloi et al. teaches an improved electronic solid-state record/playback device (SSRPD) and electronic system that may be used to record and playback information such as audio, video, control, and other data. The SSRPD uses no tape or moving parts in the actual record/playback process but includes an audio and/or video and/or other data record/playback module (RPM), which performs all of the record signal conversion, recording and data compression algorithms, digital signal processing, and playback signal conversion. The SSRPD has program input processing and control output processing modules so that other devices may be controlled in different ways including interactive control. A time and control processor module facilitates internal synchronization of the SSRPD audio, video, and control information, as well as synchronization with other devices. The SSRPD information described is recorded into an internal resident memory(s). The novel interface allows information to be exchanged without degradation via a digital Portable Storage Device (PSD) which may be a Random Access Memory card (RAM card), with other SSRPDs as well as to a special Computer Interface Device (CID). The CID is an intelligent device that connects to a standard computing device such as a PC and facilitates functions such as reading, writing, editing, and archiving PSD data, as well as performing diagnostic routines.

YET ANOTHER EXAMPLE, U.S. Pat. No. 5,642,139 to Eglit et al. teaches a motion video that may be imported into a personal or portable computer through an I/O port having a limited data bandwidth, such as a PCMCIA interface. Motion video data is compressed by sub-sampling both luminance and chrominance difference data for different sized groups of pixels. The compression apparatus may be formed on a PCMCIA card which interfaces with a personal or portable computer. Motion video data, compressed by as much as 5:1 or 6:1, is transferred through the PCMCIA card to a host computer. The host computer may serialize the compressed data and store the data in serialized compressed format in a video memory of a video controller. The video controller is provided with decompression circuitry to decompress the motion video data into luminance and chrominance difference data. The luminance and chrominance difference data is converted into RGB data and displayed in a video display.

STILL YET ANOTHER EXAMPLE, U.S. Pat. No. 5,689,732 to Kondo teaches a recording and/or reproducing system that has a recording and/or reproducing section and an interfacing unit. The recording and/or reproducing section records and/or reproduces digital data or digital signals on or from a loaded recording medium, such as a magnetic tape. The interfacing unit has a first input/output section for exchanging data and/or signals with an external equipment and a second input/output section for exchanging data and/or signals with the recording and/or reproducing section. The interfacing unit converts data and/or signals supplied from the recording/reproducing section through the second input/output section and sends the converted data and/or signals through the first input/output section to the external information equipment piece, while converting data and/or signals supplied through the first input/output section from the external information equipment piece and sending the converted data and/or signals through the second input/output section to the recording and/or reproducing section.

It is apparent that numerous innovations for multimedia input and output devices have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a portable system for inputting, editing, and outputting digital multimedia data that avoids the disadvantages of the prior art.

ANOTHER OBJECT of the present invention is to provide a portable system for inputting, editing, and outputting digital multimedia data that is simple and inexpensive to manufacture.

STILL ANOTHER OBJECT of the present invention is to provide a portable system for inputting, editing, and outputting digital multimedia data that is simple to use.

BRIEFLY STATED, YET ANOTHER OBJECT of the present invention is to provide a portable system for inputting, editing, and outputting digital multimedia data, that includes a PCMCIA memory card, a camcorder, a digital camera, a TV, and a computer. The camcorder, the digital camera, or the VCR directly receives therein the PCMCIA memory card, and records thereon, digital multimedia data of what is being recorded by the camcorder, the digital camera, or the VCR. The TV is operatively connected to the VCR. The VCR alternatively directly receives therein the PCMCIA memory card and allows the TV to play the digital multimedia data stored on the PCMCIA memory card directly received in the VCR. The computer directly receives therein the PCMCIA memory card, and saves thereon, digital multimedia data of what is being saved by the computer. The computer, alternatively, directly receives therein the PCMCIA memory card and plays the digital multimedia data recorded on the PCMCIA memory card by one of the camcorder, the digital camera, the VCR, and the computer, respectively. The computer, alternatively, directly receives therein the PCMCIA memory card and allows the digital multimedia data recorded on the PCMCIA memory card by one of the camcorder, the digital camera, the VCR, and the computer, respectively, to be edited.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a block diagram of the system of the present invention; and

FIG. 2A-2E are a flow chart of the method of using the present invention.

### LIST OF REFERENCE NUMERALS UTILIZED IN THE DRAWING

10 portable system of present invention for inputting, editing, and outputting digital multimedia data 12

12 digital multimedia data 12

14 PCMCIA memory card

16 camcorder

18 digital multimedia data of what is being recorded by camcorder 16

20 digital camera

22 digital multimedia data of what is being recorded by digital camera 20

24 VCR

26 digital multimedia data of what is being recorded by VCR 24

28 TV

30 miniature TV/VCR combo

32 computer

34 digital multimedia data of what is being saved by computer 32

36 laptop

38 data-stored PCMCIA card

### DETAILED DESCRIPTION OF THE PREFERRED EMBODIMENT

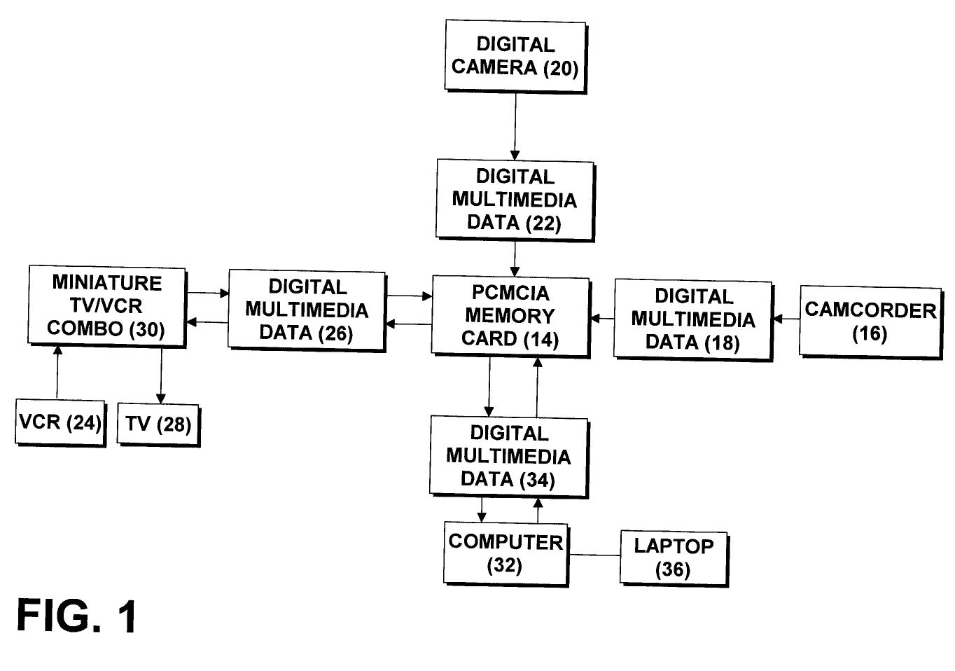

Referring now to the figures, in which like numerals indicate like parts, and particularly to FIG. 1, which is a block diagram of the system of the present invention, the portable system of the present invention is shown generally at 10 for inputting, editing, and outputting digital multimedia data 12.

The configuration of the portable system 10 can best be seen in FIG. 1, which again is a block diagram of the system of the present invention, and as such, will be discussed with reference thereto.

The portable system 10 comprises a PCMCIA memory card 14.

The portable system 10 further comprises a camcorder 16 that directly receives therein the PCMCIA memory card 14, and records thereon, digital multimedia data 18 of what is being recorded by the camcorder 16.

The portable system 10 further comprises a digital camera 20 that directly receives therein the PCMCIA memory card 14, and records thereon, digital multimedia data 22 of what is being recorded by the digital camera 20.

The portable system 10 further comprises a VCR 24 that directly receives therein the PCMCIA memory card 14, and records thereon, digital multimedia data 26 of what is being recorded by the VCR 24.

The portable system 10 further comprises a TV 28 that is operatively connected to the VCR 24.

The VCR 24 alternatively directly receives therein the PCMCIA memory card 14 and allows the TV 28 to play the digital multimedia data 18, 22, 26, 34 stored on the PCMCIA memory card 14 directly received in the VCR 24.

The VCR 24 and the TV 28 can be combined in a miniature TV/VCR combo 30.

The portable system 10 further comprises a computer 32 that directly receives therein the PCMCIA memory card 14, and saves thereon, digital multimedia data 34 of what is being saved by the computer 32.

The computer 32, alternatively, directly receives therein the PCMCIA memory card 14 and plays the digital multimedia data 18, 22, 26, 34 recorded on the PCMCIA memory card 14 by one of the camcorder 16, the digital camera 18, the VCR 20, and the computer 26, respectively.

The computer 32, alternatively, directly receives therein the PCMCIA memory card 14 and allows the digital multimedia data 18, 22, 26, 34 recorded on the PCMCIA memory card 14 by one of the camcorder 16, the digital camera 18, the VCR 20, and the computer 26, respectively, to be edited.

The computer 32 can be a laptop 36.

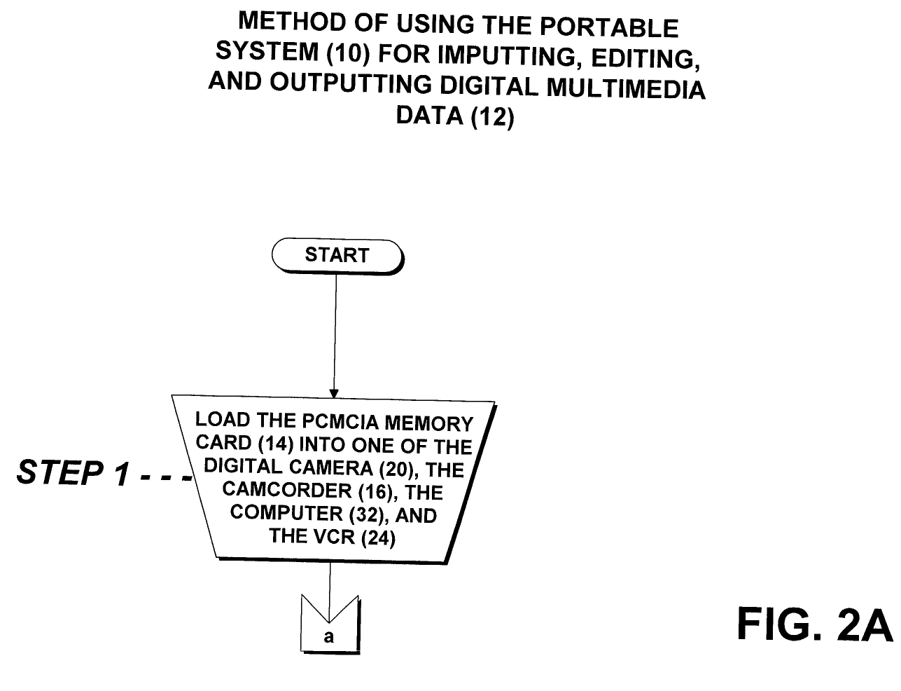

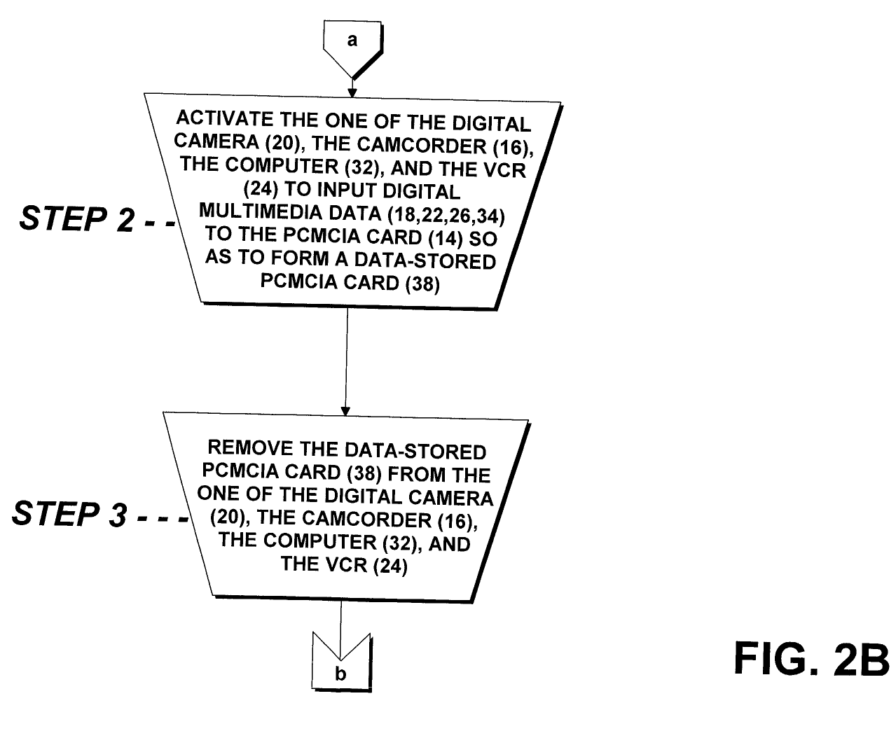

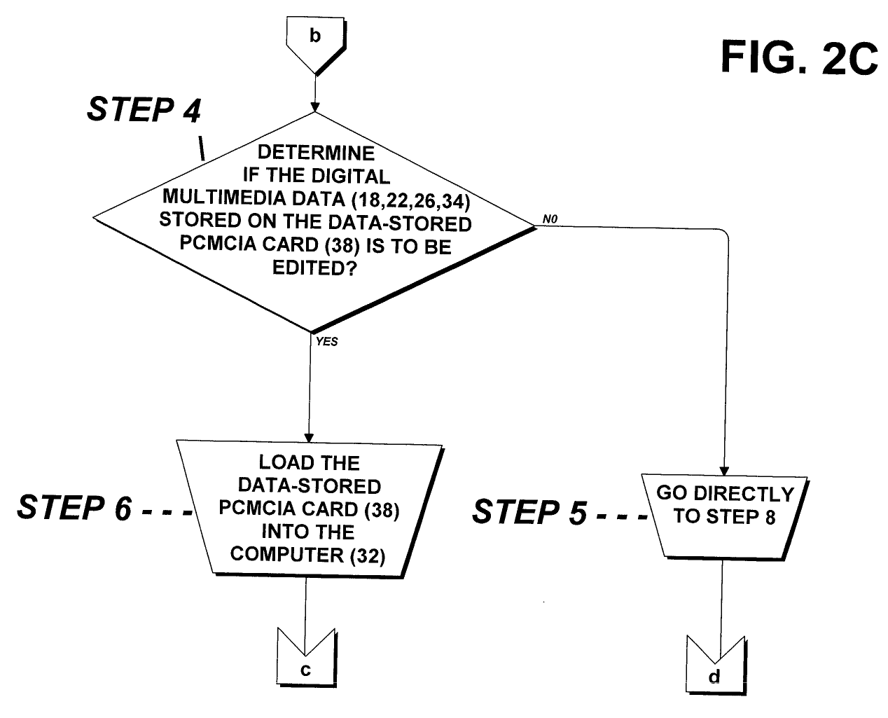

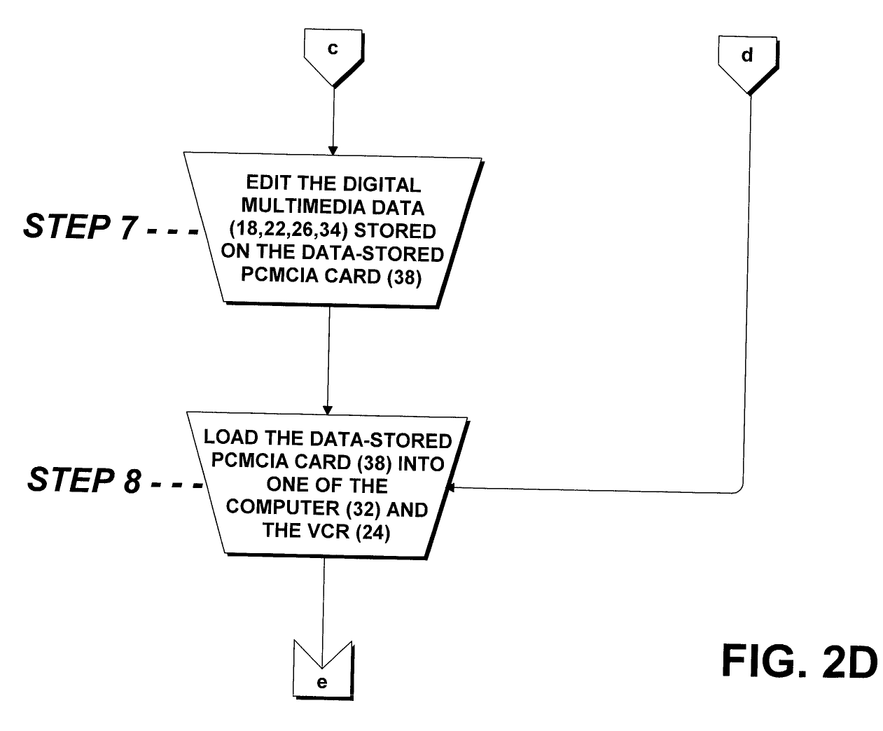

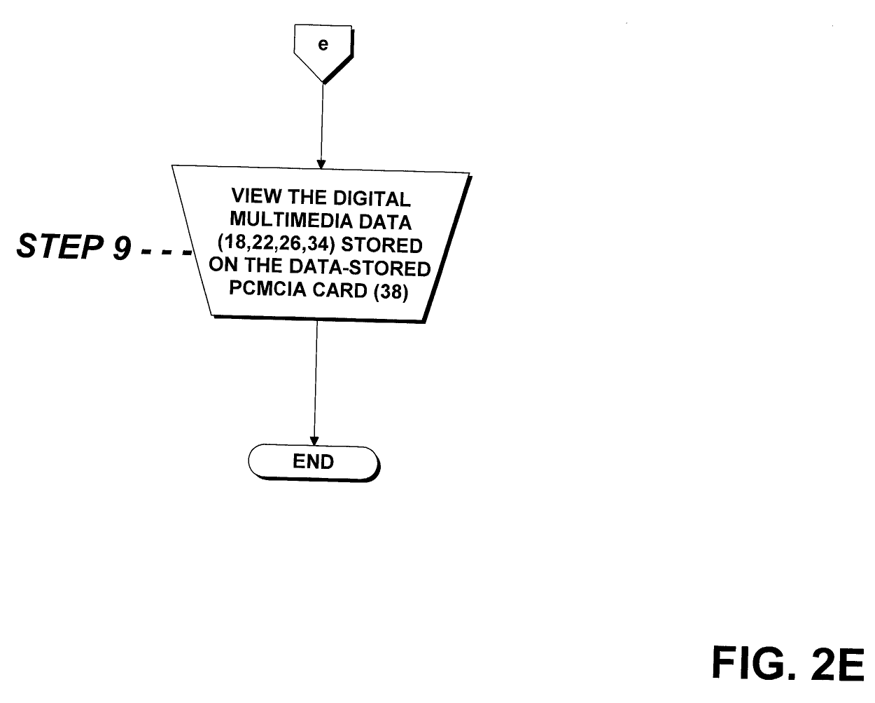

The method of using the portable system 10 for inputting, editing, and outputting digital multimedia data 12 can best be seen in FIGS. 2A-2E, and as such, will be discussed with reference thereto.

| | |
|---|---|
| STEP 1: | Load the PCMCIA memory card 14 into one of the digital |
| | camera 20, the camcorder 16, the computer 32, and the VCR |
| | 24. |
| STEP 2: | Activate the one of the digital camera 20, the camcorder |
| | 16, the computer 32, and the VCR 24 to input digital |
| | multimedia data 18, 22, 26, 34 to the PCMCIA memory card |
| | 14 so as to form a data-stored PCMCIA card 38. |
| STEP 3: | Remove the data-stored PCMCIA CARD 38 from the one of the |
| | digital camera 20, the camcorder 16, the computer 32, and |
| | the VCR 24. |
| STEP 4: | Determine if the digital multimedia data 18, 22, 26, 34 |
| | stored on the data-stored PCMCIA card 38 is to be edited? |
| STEP 5: | Go directly to STEP 8, if answer to STEP 4 is no. |
| STEP 6: | Load the data-stored PCMCIA card 38 into the computer 32, |
| | if answer to STEP 4 is yes. |
| STEP 7: | Edit the digital multimedia data 18, 22, 26, 34 stored on |
| | the data-stored PCMCIA card 38, if STEP 6 is performed. |
| STEP 8: | Load the data-stored PCMCIA card 38 into one of the |
| | computer 32 and the VCR 24. |
| STEP 9: | View the digital multimedia data 18, 22, 26, 34 stored on |
| | the data-stored PCMCIA card 38. |

It will be understood that each of the elements described above, or two or more together, may also find a useful application in other types of constructions differing from the types described above.

While the invention has been illustrated and described as embodied in a portable system for inputting, editing, and outputting multimedia, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A portable system for inputting, editing, and outputting digital multimedia data, comprising:
a) a PCMCIA memory card;
b) a camcorder directly receiving therein said PCMCIA memory card, and recording thereon, digital multimedia data of what is being recorded by said camcorder;
c) a digital camera directly receiving therein said PCMCIA memory card, and recording thereon, digital multimedia data of what is being recorded by said digital camera;
d) a VCR directly receiving therein said PCMCIA memory card, and recording thereon, digital multimedia data of what is being recorded by said VCR;
e) a TV operatively connected to said VCR; said VCR alternatively directly receiving therein said PCMCIA memory card and allowing said TV to play said digital multimedia data stored on said PCMCIA memory card by one of said camcorder, said digital camera, said VCR, and said computer, directly received in said VCR; and
f) a computer directly receiving therein said PCMCIA memory card, and saving thereon, digital multimedia data of what is being saved by said computer; said computer, alternatively, directly receiving therein said PCMCIA memory card and playing said digital multimedia data recorded on said PCMCIA memory card by one of said camcorder, said digital camera, said VCR, and said computer, respectively; said computer, alternatively, directly receiving therein said PCMCIA memory card and allowing said digital multimedia data recorded on said PCMCIA memory card by one of said camcorder, said digital camera, said VCR, and said computer, respectively, to be edited.

2. The system as defined in claim 1, wherein said VCR and said TV are combined in a miniature TV/VCR combo.

3. The system as defined in claim 1, wherein said computer is a laptop.

4. A method of using a portable system for inputting, editing, and outputting digital multimedia data, comprising the steps of:
a) loading a PCMCIA card of said portable system into one of a digital camera of said portable system, a camcorder of said portable system, a computer of said portable system, and a VCR of said portable system;
b) activating said one of said digital camera, said camcorder, said computer, and said VCR to input digital multimedia data to said PCMCIA card so as to form a data-stored PCMCIA card;
c) removing said data-stored PCMCIA CARD from said one of said digital camera, said camcorder, said computer, and said VCR;
d) determining if said digital multimedia data stored on said data-stored PCMCIA card is to be edited;
e) going directly to step h), if answer to step d) is no;
f) loading said data-stored PCMCIA card into said computer, if answer to step d) is yes;
g) editing said digital multimedia data stored on said data-stored PCMCIA card, if step f) is performed;
h) loading said data-stored PCMCIA card into one of said computer and said VCR; and
i) viewing said digital multimedia data stored on said data-stored PCMCIA card.

5. The method as defined in claim 4, wherein said step of loading a PCMCIA card of said portable system into one of a digital camera of said portable system, a camcorder of said portable system, a computer of said portable system, and a VCR of said portable system includes loading a PCMCIA card of said portable system into one of a digital camera of said portable system, a camcorder of said portable system, a computer of said portable system which is a laptop, and a VCR of said portable system.

6. The method as defined in claim 4, wherein said step of loading said data-stored PCMCIA card into one of said computer and said VCR includes loading said data-stored PCMCIA card into one of said computer and said VCR which is operatively connected to a TV of said portable system.

7. The method as defined in claim 6, wherein said step of loading said data-stored PCMCIA card into one of said computer and said VCR which is operatively connected to a TV of said portable system includes loading said data-stored PCMCIA card into one of said computer and a miniature TV/VCR combo of said portable system.

8. The method as defined in claim 6, wherein said step of viewing said digital multimedia data stored on said data-stored PCMCIA card includes viewing said digital multimedia data stored on said data-stored PCMCIA card on one of said computer and said TV.
